(19) United States
(12) Patent Application Publication
(10) Pub. No.: US 2003/0187691 A1
(43) Pub. Date: Oct. 2, 2003

(54) Method and system for matching a service seeker with a service provider

(75) Inventors: Amitabh K. Dutt, Tiburon, CA (US); Bernard M. Berlin, San Anselmo, CA (US)

Correspondence Address: JEFFER, MANGELS, BUTLER & MARMARO, LLP, 1900 AVENUE OF THE STARS, 7TH FLOOR, LOS ANGELES, CA, 90067, US

(73) Assignee: Health Net, Inc.

(21) Appl. No.: 10/113,536

(22) Filed: Mar. 28, 2002

(51) Int. Cl. G06F 17/60

(52) U.S. Cl. 705/2

(57) ABSTRACT

A referral system in which input by a service seeker describing a need provides accurate, consistent, and reliable referrals to qualified service providers. The referral system is created and maintained by a host having extensive knowledge and experience in the field in which referrals are being sought by service seekers. Through this knowledge base and experience, the host is able to derive an accurate, comprehensive list of needs from which a service seekers can select the specific service being sought. The host also derives a list of needs that can be serviced by a service provider by examining qualitative and/or quantitative factors of a service provider. This needs list is derived for each service provider. This is also done most effectively by a host having extensive knowledge and experience in the relevant field. The host takes the selected needs of the service seekers, along with information such as the service seeker's geographic location, and provides a list of one or more service providers most appropriate for the service seeker. The referral system can be used in the health care industry where the host is a health service organization. The service seeker is a health care consumer seeking mental or physical health services from a qualified health care provider.

### FIELD OF THE INVENTION

The present invention relates to methods and systems for providing referrals between entities. In particular, it relates to methods of matching an entity seeking a service with an entity qualified to provide the service. In a preferred embodiment, the methods and systems are used to match a health care consumer with an appropriate health care provider using specifics of the health care consumer's condition to identify one or more qualified health care providers.

### BACKGROUND OF THE INVENTION

We live in an increasingly service-oriented society. As individuals, we often find ourselves in need of a some type of service. The range of services (and any related goods) available to us is astonishing. Occasionally, a service seeker, more or less aware of the type or nature of the service needed, may not be aware of the specific type of service provider most suitable, much less actual service providers available to provide the service. For example, an individual is aware that he or she needs an attorney to handle a child custody issue but may not know that an attorney specializing in domestic relations is the most suitable type of attorney. In another example, a small business entity is well aware that it needs to install computers and printers in its offices and needs a consultant but may not know that it specifically requires a consultant specializing in computer networking and setting up peripherals. Furthermore, in both instances, the service seeker, i.e., the individual or small business entity, may not know how to search for the appropriate service provider, other than starting with the yellow pages.

Perhaps the type of service of utmost importance to individuals is in the medical field, specifically mental and physical health services. As many have become aware, the infrastructure of the health care establishment has grown significantly in recent times. A service seeker, in this case a health care consumer, may be aware of the nature of the service needed, that is to say, is aware of the condition or ailment. However, the health care consumer may not know which specialty, if any, is most suitable for addressing the condition or how to obtain an appropriate referral to a health care provider.

Presently, there are numerous avenues a health care consumer may take in seeking a referral to a doctor or other health care provider. For example, a health care consumer may ask her primary care physician for a referral in the course of an office visit. The consumer may also obtain a referral by making a phone call to a health care organization or insurance company and make selections from automated telephone menus until the consumer is speaking with a person. Such a person is often referred to as an intaker, of which there may be dozens at a typical health care organization. An intaker typically accesses the health care consumer's complaints or symptoms and derives a condition for that consumer. That is, the consumer explains, often in layman or non-medical terms, the symptoms or problems he or she is experiencing and the intaker or clinician classifies the symptoms into one or more conditions. The intaker then identifies the appropriate health care provider for the consumer. Identifying the appropriate provider may involve various criteria. In some cases, the criteria may simply be a provider within a certain geographical area, e.g. zip code, and who is qualified under the consumer's health care plan. Or a health care consumer may specify a preference to see a female provider with fluency in a particular language. Other more sophisticated criteria may include searching for providers having a specialty in treating that particular condition. Determining whether a provider has a specialty in a particular area can also vary in sophistication.

In any case, the health care consumer must make a phone call and speak to an intaker or clinician before obtaining a referral. This process can be inefficient for both parties; it is also potentially frustrating to the consumer who can only obtain direct assistance during member service hours—typically 8 am to 5 pm. Simultaneously, it is costly to the health care organization which has to provide the staff and infrastructure for the referral system. Moreover, the administration of the referral system may not be consistent. That is, two consumers with the same condition and living in the same area who call and speak to different intakers may be referred to different health care providers. This can be the case if one intaker is more experienced than the other or because one intaker has consistently referred health care consumers having a particular symptom to one physician thinking that that particular physician is best suited to handle that condition. Patient/physician referral systems in place today can be inconsistent to some degree. They also often do not take advantage of online capabilities which increasingly are becoming the preferred method for communicating with the health care organization for many health care consumers.

The same issues arise in service industries besides health care. Going back to the attorney referral example, persons or other entities seeking legal services are in need of a client/attorney referral system that directs them to an attorney having expertise in dealing with a specific type of problem. More generally, an intuitive and user-friendly service seeker/service provider referral system that matches a seeker with qualified providers based on the seeker's layperson—description of the service being would be useful in any service-oriented industry.

### SUMMARY OF THE PREFERRED EMBODIMENTS

Methods and systems for creating and maintaining a service seeker/service provider referral system that reliably and accurately refers an entity in need of service to appropriate service provider based on input of a general nature from the entity are described.

In one aspect of the present invention, a method of creating a referral system for referring an entity in need of a service in a particular field to another entity qualified to provide the service is described. The referral system of the present invention is created and maintained by host. A host can be any party that either directly has knowledge of the particular field in which the service is being offered or has gained access to such knowledge. In some cases a host may be a party that does not provide the actual service but has knowledge of the service field and of the actual service providers. Examples include local bar associations, health care organizations, unions, chambers of commerce, professional societies, and so on. A host can also be a commercial entity that provides the referral system to its customers or users and gains access to the required knowledge from another entity. For example, a web portal acting as a host may offer such a referral system to its users wherein the system and methodology for creating the system is handled by another entity, such as a health care organization or bar association. A host can also be a service provider having the requisite knowledge of the service field. For example, a host may be a law firm, a computer software company, an HMO or PPO, or any other type of commercial entity. The referral system is created and maintained by a host or is provided to service seekers by the host. In any case, the host creates a list of needs by examining historical data. Historical data is data previously received by the host from numerous past service seekers who have contacted the host for a referral and provided the host with information about their needs, conditions, situation, and so on. For example, such information may include statements such as “I'm having difficulty sleeping,” “I've been served with an eviction notice,” or “I'd like to remodel my kitchen.” In a preferred embodiment, this historical data is derived from actual data records of communications from service seekers and the collective experience of the personnel receiving the communications.

The host, being familiar with service providers in its field, creates a list of one or more specialties for each service provider. In the health care field, for example, a service provider may be a physician, therapist, dietician or psychiatrist, among others. The list of specialties is created by examining either a set of quantitative factors relating to the service provider or a set of qualitative factors or a combination of both. Specialties of a service provider are examined in light of the list of needs to determine which needs the service provider is qualified to handle. For example, a computer consultant having a specialty in Windows NT software is qualified to handle the need of “setting up computers in my office or home.” In another example, a medical professional with experience in nutrition and diet is qualified to handle the condition of “feeling tired and low energy during the day” and is considered to have a specialty suitable for treating or handling this condition. The operation of matching a service provider with the service seeker is performed by the host through an electronic, telephonic, or computer network using the referral system of the present invention. Deriving the list of needs and the operation of determining which needs can be handled by a service provider is performed most effectively by a host with extensive experience in the particular field and having a substantial knowledge base pertaining to the actual service providers.

In one embodiment the referral system is a health care consumer referral system in the field of mental and physical health where the host is a health care organization. A consumer logs into the referral system and then enters a condition, such as a mental health condition or a physical ailment, and a geographic location. The consumer is then provided with a referral to a health care provider specializing in treating the condition in the consumer's geographic area. In another embodiment the host creates the list of conditions by examining data from previous consumers calling in to obtain referrals and using the host's extensive experience and knowledge base in the particular field. In another embodiment the evaluation of the health care provider's background, training, experience and so on is performed by a host also using the host's extensive knowledge in the field and the host's familiarity and working relationships with the service providers.

In another aspect of the present invention, a consumer referral system is implemented on a computer system, such as on a web server or a server in an entity's Intranet, containing one or more processors and one or more memory storage areas. The memory storage areas contain various types of data including a list of conditions from which a health care consumer can make a selection. The memory storage areas in the computer system also store multiple specialty lists where each specialty list is associated with a health care provider. The memory storage areas also contains multiple provider-specific condition lists associated with a health care provider.

In one embodiment the service-seeker uses a telephone to access the referral system. In another embodiment, the service seeker uses a portable IP-addressable device to communicate or interact with the referral system. In yet another embodiment, the referral system can be accessed through an internet appliance or interactive/web-enabled television. In yet another embodiment, the referral system can be used for services outside the health care field as described above. Examples of other fields in which the referral system can be used include the dental services, legal services, business-related services such as accounting, tax and so on, engineering or technical services such as computer services, and residential or home services, to mention a few.

### BRIEF DESCRIPTION OF THE DRAWINGS

FIG. 1 is a flow diagram of a process in which a health care consumer referral system is created in accordance with one embodiment of the present invention.

FIG. 2 is a block diagram showing an overview of the process of deriving a list of needs in accordance with one embodiment of the present invention.

FIG. 3 is a block diagram showing a process for matching a health care provider with a list of conditions in accordance with one embodiment of the present invention.

### DETAILED DESCRIPTION OF THE PREFERRED EMBODIMENTS

A referral system and method in which an entity seeking a service is matched with an appropriate service provider based on a description of the need of the entity seeking the service is described in the various figures. The referral system can be used in any service-oriented industry. In a preferred embodiment, the referral system is created and maintained by a third-party entity referred to as a host. In another preferred embodiment the host obtains access to the knowledge necessary to create and maintain the referral system.

A host can be any party that either directly has knowledge of the particular field in which the service is being offered or has gained access to such knowledge. In some cases a host may be a party that does not provide the actual service but has knowledge of the service field and of the actual service providers. Examples include local bar associations, health care organizations, unions, chambers of commerce, professional societies, and so on. A host can also be a commercial entity that provides the referral system to its customers or users and gains access to the required knowledge from another entity. For example, a web portal acting as a host may offer such a referral system to its users wherein the system and methodology for creating the system is handled by another entity, such as a health care organization or bar association. A host can also be a service provider having the requisite knowledge of and experience in the service field. For example, a host may be a law firm, a computer software company, an HMO or PPO, or any other type of experienced commercial entity. The referral system of the present invention is created and maintained by a host or is provided to service seekers by the host.

In a preferred embodiment, the host creates and maintains the referral system and utilizes the experience and knowledge base of its referral personnel, thereby provides service seekers with consistent, reliable referrals in an efficient manner. Referral personnel are individuals who listen to the needs, conditions, situations, predicaments, and so on of those seeking a referral to an appropriate service provider. As described in greater detail below, referral personnel in a health care organization are referred to as intakers. In another preferred embodiment the host maintains the referral system and utilizes, perhaps through a licensing arrangement, the experience and knowledge base of referral personnel of another entity.

The referral system can be implemented on a computer, electronic, or telephonic network. In a preferred embodiment, the system is implemented on a web site on the Internet and made available to individuals having the required login information. In another preferred embodiment, the referral system is implemented on a web site and available to the general public. It can also be implemented on a host's internal computer network or on a host's Intranet, a computer network based on the TCP/IP protocol. In another preferred embodiment, the referral system is implemented on a telephone system and can be accessed by service seekers via telephone. In a preferred embodiment, the service seeker is a health care consumer, specifically a health care consumer seeking an appropriate mental health service provider (hereinafter referred to as “provider” in the preferred embodiment). Examples of such providers include psychiatrists, therapists, counselors, analysts, and psychologists. In other preferred embodiments, the consumer may be seeking a physical health service provider. In a preferred embodiment the host is a health care organization. Examples of health care organizations include health insurance companies, HMOs and PPOs. As described above, alternatively, the host can be a commercial vendor or other entity which gains access or obtains the requisite knowledge from another entity having the knowledge and experience. The referral system of the present invention is created and maintained by a host with access to a significant knowledge base of the field in which services are being sought and of the service providers. Typically, this knowledge base is developed over time by the host by interacting with service seekers, obtaining knowledge of service provider qualifications, and through exposure to and experience in the particular service industry.

The host providing the referral system has, typically over many years, developed an expertise in listening to needs of service seekers. That is, the host is typically very familiar with the needs of the public and to what type of service providers are most suitable for meeting those needs. As mentioned above, in a preferred embodiment, the service seeker is a health care consumer with needs in the area of mental health. In another preferred embodiment the consumer's needs are in the area of physical health. In yet another preferred embodiment, the consumer's needs are in the dental field. The referral personnel of a health care organization listening to or communicating with the consumer are known as intakers. In some health care organizations they are referred to as clinicians. A consumer typically tells the intaker the problem or symptom he is experiencing in layman or non-medical terms. The intaker processes this information, classifies it, and locates a qualified provider in the consumer's geographic area.

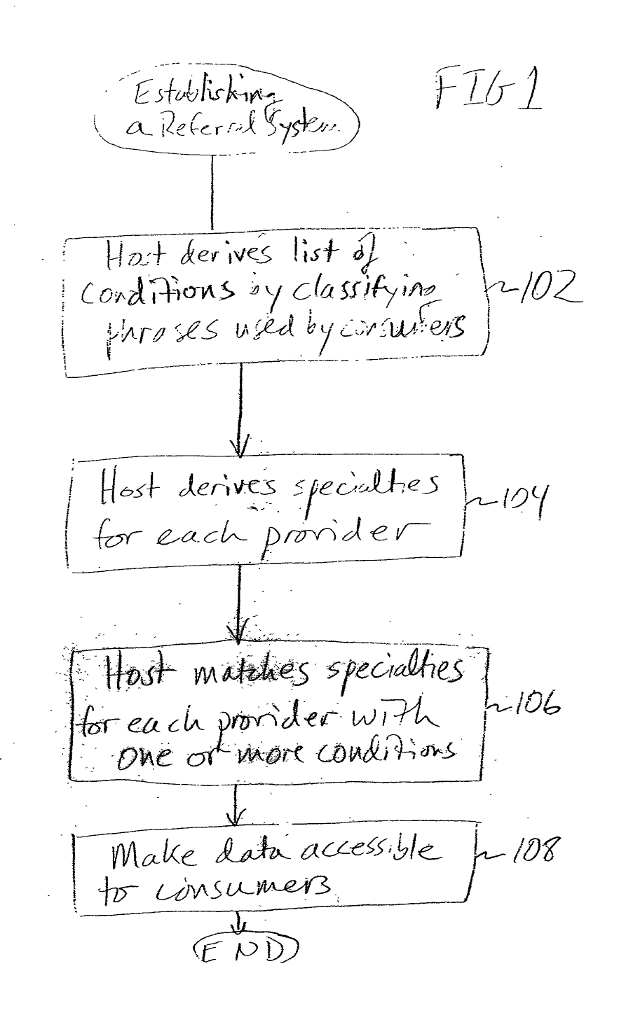

FIG. 1 is a flow diagram of a process in which a health care consumer/provider referral system is created in accordance with one embodiment of the present invention. At step 102 the intakers at a health care organization derive a list of needs by classifying phrases used by health care consumers calling in seeking a referral. In a preferred embodiment, the list of needs is more specifically described as a list of mental health conditions. Common phrases used by consumers are clustered into conditions for use in the referral system. The list of mental health conditions includes the following: marital issues, family relations, work problems, stress issues, depressed feeling, anxiety issues, drug issues, alcohol issues, grief, sexual problems, issues with children ages 1-5, issues with children ages 6-12, adolescent issues, “other”, and “rather not tell.” This list is derived with the goal of covering as many general conditions as feasible. In another preferred embodiment, the list includes the following physical health conditions: wellness examinations for 16 and under, wellness examinations for over 16, visual problems, cancer, hepatitis, coronary conditions, and diabetes. In fields besides health care, the list of needs may not be of conditions but rather actual needs, e.g., the need for repairing a roof or the need for a French instructor, or a list of situations, e.g., “I have been fired because of my disability” or “I was in an accident.”

In a preferred embodiment, phrases commonly used by consumers are clustered into conditions that capture or describe the problems they are experiencing. This clustering of phrases and terms commonly used by consumers into a list of conditions is done most effectively by intakers at the health care organization having significant experience listening to consumers and distilling from their complaints and symptoms one or more specific conditions. It is the collective experience of the employees at the health care organization that enables deriving an effective list of conditions with which consumers can identify and relate. Similarly, in other fields, the knowledge base and collective experience of the host, such as a bar association or professional society, enables the creation of an effective list of needs. This list effectively replaces the past requirement that the consumer make a phone call to the host and describe their problem or symptoms verbally. With the referral system of the present invention, the service seeker simply selects from a list of needs those entries that best describe the nature of the service being sought.

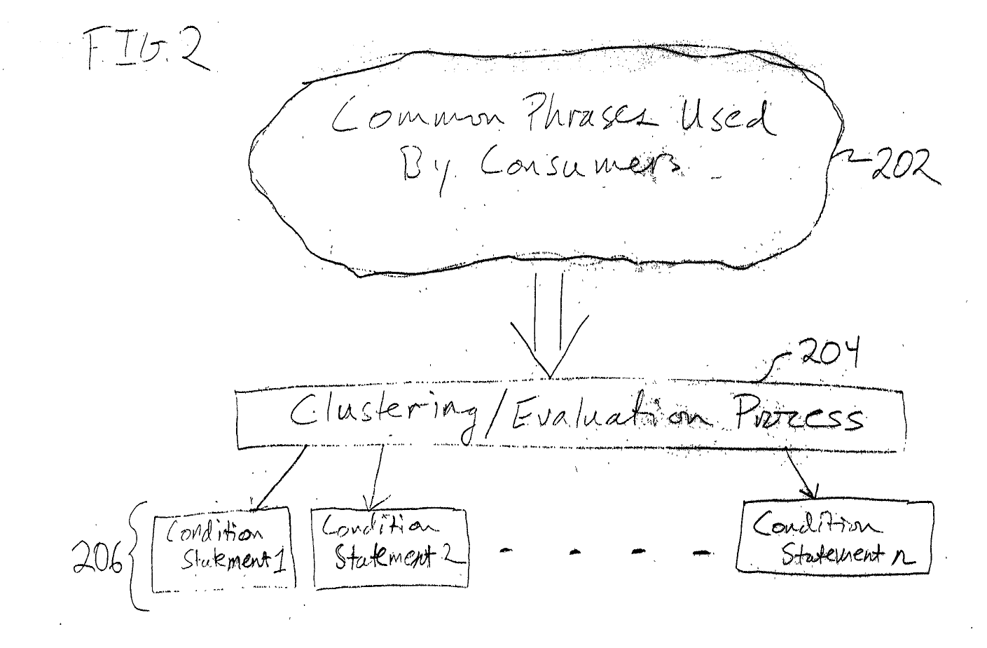

FIG. 2 is a block diagram showing an overview of a process of deriving a list of needs in accordance with one embodiment of the present invention. A collection of common phrases and words 202 used by consumers is collected by intakers or other employees at a health care organization. The collection of phrases 202 and other relevant data is processed and clustered by the organization as represented by box 204. A list of condition statements 206 of conditions 1 through n is derived from process 204.

At step 104 the health care organization examines the backgrounds, education, training, and experience of its mental health care providers. In the preferred embodiments, the organization evaluates this information for each mental health care provider. The methods used to evaluate a provider and classify a provider into one or more “specialties' can vary in different health care organizations. A formulaic approach can be used in which quantitative factors such as areas of specialization, stated interests, degrees, type of training, honors or awards received and so on are used to classify a provider. In another preferred embodiment, a more qualitative approach can be used in which the same factors are considered in addition to qualitative factors such as interviewing the provider to see what his or her professional interests are to determine the provider's alignment with a specific condition. Either approach can be used in other fields for classifying service providers. For example, in the legal field, attorney expertise can be classified by number of years of experience, past client recommendations, bar association memberships, and so on. By the end of step 104, each mental health care provider is assigned one or more specialties. Similar to deriving the conditions in step 102, evaluating the backgrounds and experience of each provider is performed most effectively by a host having significant experience working with providers and having familiarity with their backgrounds and practice. For example, an electricians'union may have the most familiarity and experience with the backgrounds and practice of electricians in a particular geographical area.

At step 106 the health care organization matches each mental health care provider with one or more conditions from the list of conditions for which the provider's specialty is identified as a referral match. This matching operation is a qualitative process in which the organization, again, using its extensive experience and expertise in the health care field, takes the specialties assigned to each provider derived at step 104 and matches each specialty with one or more conditions from the list of conditions. Through this process a correlation is made between a service provider and the needs the service provider is qualified to handle or meet. That is, a service provider/need correlation is created. Thus, in a preferred embodiment, each mental health care provider participating in the health care consumer referral system is correlated with at least one condition. In this manner a sublist of conditions is derived for each health care provider. The sublist contains one or more conditions that the provider is suited to handle. In another example, an attorney is correlated with one or more needs or situations such as “I have been served with an eviction notice” or “I need to prepare a will.” In another preferred embodiment, each service provider is associated with a service provider-specific needs the service provider is best suited to handle. The referral system contains numerous service provider-specific needs lists.

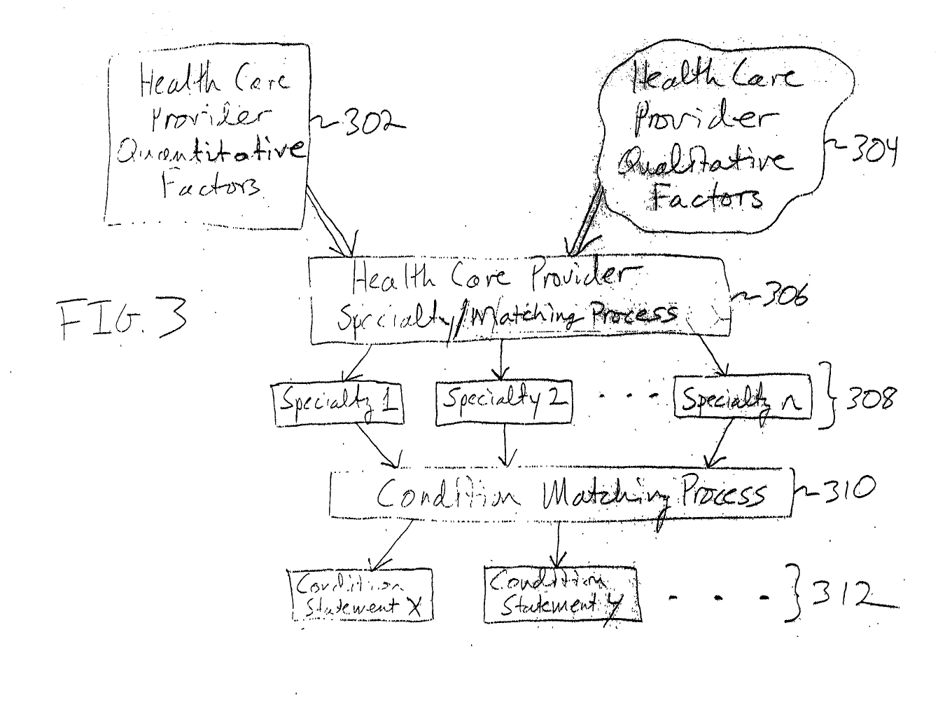

FIG. 3 is a block diagram showing a process for matching a health care provider with a list of conditions, given the matching criteria previously described. The process uses a set of quantitative factors 302 and a set of qualitative factors 304 as input to a specialty matching process represented by box 306. As described above, a set of quantitative factors 302 and a set of qualitative factors 304 are used as input to a specialty evaluation process represented by box 306. In another preferred embodiment, only set 304 is used as input to box 306 or only set 302 is used as input. A list of specialties 308 containing one or more specialties is derived. This list of specialities corresponds to a particular health care provider. List 308 is used as input to a condition matching engine shown as box 310. Here the process of matching specialties with conditions is performed. The output from box 310 is a list of condition statements 312 for which the provider is qualified to treat.

At step 108 the data derived from the steps above is stored electronically and made available on a web site or Intranet site to eligible consumers. At this stage the data can be utilized by consumers via a user interface.

In a preferred embodiment, an eligible consumer logs onto a web site or intranet site hosting the health care consumer referral system. In another preferred embodiment, the consumer accesses the referral system using a telephone. In another preferred embodiment, the referral system can be used with interactive television or web-based television in which the consumer logs in and obtains referrals via television after entering the necessary input. After logging in, the consumer selects one or more conditions and his or her geographic location. The system displays a list of qualified mental health care providers in the consumer's geographic area from which the consumer can choose. The consumer communicates by telephone or electronically with the providers and schedules an appointment with one of them through the referral system or contacts the provider to make an appointment. In another preferred embodiment, the consumer returns to the referral site and enters the provider's name. At this point the health care organization sends a confirmation message to the provider.

Although a preferred embodiment of the referral system of the present invention has been described in the context of a mental health care consumer/provider referral system, the processes described can be used in other service industries where a service seeker is in need of a referral to a provider of services or goods and where the provider can be selected based on certain criteria or characteristics. As noted, it can be used in the physical health field for which numerous conditions can be listed or in the dental services field. Other areas in which the system can be used vary from the legal field to interior designers. For example, designers can have various specialties, such as residential homes, public spaces, commercial space, landscaping, interiors, and so on. The equivalent of a condition may be “Need professional services for decorating a new home” or “Need services for designing a public recreational area” and the like. In the attorney referral scenario, a condition or need might be “I have been served with an eviction notice” or “I am starting a new business” and the like. The system is more effective if the organization hosting and maintaining the referral site has significant experience and knowledge in the particular field. For example, a professional association of designers and architects would be well suited for hosting the design services site. This experience and knowledge is what enables the effective clustering of common phrases and words into “conditions” or equivalent, the evaluation of the providers'specialties, and the matching of the specialties to the conditions.

What is claimed is:

1. A method of creating a referral system for referring a service seeker to a service provider, the method comprising:
creating a plurality of needs;
creating at least one specialty by examining a first set of factors characterizing the service provider;
matching the at least one specialty of the service provider with at least one need from the plurality of needs thereby creating a service provider/need correlation; and
making the service provider/need correlation available to a plurality of service seekers through the referral system.

2. A method as recited in claim 1 wherein creating a plurality of needs further includes examining historical data provided by previous service seekers.

3. A method as recited in claim 2 wherein the historical data is examined by a host having knowledge of a field in which the service provider provides a service.

4. A method as recited in claim 1 wherein the service seeker is a health care consumer and the service provider is a health care provider.

5. A method as recited in claim 4 wherein the referral system is created and maintained by a health care organization familiar with the health care field and using the historical data to create the plurality of needs.

6. A method as recited in claim 5 wherein the health care organization derives the at least one specialty of the service provider using a set of qualitative factors characterizing to the service provider.

7. A method as recited in claim 5 wherein the health care organization creates the at least one specialty of the service provider using a set of quantitative factors characterizing to the service provider.

8. A method as recited in claim 1 wherein the service provider/need correlation is stored on a computer system wherein the correlation is accessible to a plurality of service seekers.

9. A method of referring a service seeker to a service provider, the method comprising:
entering one or more needs from a list of needs, wherein the list of needs is derived from historical need data;
selecting from a list of one or more service providers qualified to handle the one or more needs, wherein qualifications of a service provider are based on a set of qualitative data; and
obtaining contact information for one or more service providers.

10. A method as recited in claim 9 wherein the list of needs is compiled by a host having access to a knowledge base in a field in which the service seeker is seeking a service provider.

11. A method as recited in claim 9 wherein the list of needs is compiled by a host having experience communicating with service seekers seeking services in a particular field.

12. A method as recited in claim 9 wherein the qualifications of a service provider are evaluated based on a set of quantitative data.

13. A method as recited in claim 9 wherein the list of needs is derived from previous communications with service seekers relating to needs of the service seekers.

14. A method of creating a health care consumer referral system for referring a health care consumer to a health care provider, the method comprising:
creating a list of conditions from which the consumer selects one or more conditions;
deriving for a health care provider a sublist of conditions for which the health care provider is qualified to handle each condition in the sublist; and
making the list of conditions available to the consumer whereby selecting a condition results in informing the consumer of one or more health care providers qualified for treating the selected condition.

15. A method as recited in claim 14 wherein the health care consumer referral system is created by a health care organization having access to knowledge of health care consumer conditions in the health care field wherein such knowledge is used by the health care organization to derive the list of conditions.

16. A method as recited in claim 15 further comprising using data known about the health care provider and the knowledge of health care consumer conditions to derive the sublist of conditions for a health care provider.

17. A method of creating a consumer and health care provider referral system for referring a consumer to a health care provider, the method comprising:
creating a list of conditions utilizing a knowledge base of a host from which a consumer selects one or more conditions, the knowledge base derived from previous input from a plurality of consumers;
creating a sublist of conditions for a health care provider based on qualifications of the provider; and
making the list of conditions available to the consumer whereby selecting one or more conditions results in obtaining one or more health care providers suitable for treating the selected one or more conditions.

18. A method as recited in claim 17 wherein the list of conditions is a list of mental health conditions.

19. A method as recited in claim 17 wherein the list of conditions is a list of physical health conditions.

20. A method as recited in claim 17 wherein the list of conditions is a list of mental health and physical health conditions.

21. A method as recited in claim 17 wherein creating a sublist of conditions for a health care provider further includes deriving one or more specialties of the health care provider using a quantitative set of criteria.

22. A method as recited in claim 21 wherein deriving one or more specialties for the health care provider using a quantitative set of criteria further includes using a qualitative set of criteria.

23. A method of creating a consumer and health care provider referral system for referring a consumer to a health care provider, the method comprising:
creating a list of conditions using a knowledge base of a host from which a consumer selects one or more conditions;
creating a sublist of conditions for a health care provider; and
making the list of conditions available to the consumer whereby selecting one or more conditions results in displaying one or more health care providers suitable for treating the selected one or more conditions.

24. A method as recited in claim 23 wherein the knowledge base of the host is derived from condition data provided by a plurality of consumers.

25. A method of using a service seeker/service provider referral system comprising:
entering a need;
entering a geographic area;
obtaining a list of qualified service providers suitable for handling the need; and
entering appointment information for a selected service provider.

26. A method as recited in claim 25 wherein the need is a mental health condition or a physical health condition.

27. A method as recited in claim 25 wherein the need is in the legal field.

28. A method as recited in claim 25 further including contacting one of the service providers to schedule an appointment.

29. A method as recited in claim 25 further comprising presenting a list of needs from which a service seeker can select a need.

30. A computer system for referring a service seeker to a service provider comprising:
one or more processors; and
one or more memory storage areas containing:
a list of needs made available to a service seeker;
a plurality of specialty lists, a specialty list associated with a service provider; and
a plurality of service provider-specific needs lists, a service provider-specific needs list associated with a service provider and containing one or more needs that can be handled by the service provider.

31. A referral system comprising:
a plurality of needs from which a service seeker can select one or more needs for which a referral is sought, the plurality of needs being derived in part from historical data;
a plurality of specialty lists, a specialty list corresponding to a service provider and derived by examining a first set of factors;
a matching engine for matching a specialty from the specialty list with a need from the plurality of needs thereby creating a service provider/need correlation; and
a graphical user interface for displaying data to a service seeker.

32. A referral system as recited in claim 31 wherein the plurality of needs is derived from previous communications with service seekers.

33. A referral system as recited in claim 32 wherein the plurality of needs is comprised of mental health conditions.

34. A referral system as recited in claim 32 wherein the plurality of needs is comprised of physical health conditions.

35. A referral system as recited in claim 31 wherein the specialty list corresponding to a service provider is created from a set of qualitative factors and a set of quantitative factors relating to the service provider.

36. A referral system as recited in claim 31 wherein the service provider/need correlation is created from the specialty list corresponding to the service provider.
